(19) United States
(12) Patent Application Publication
(10) Pub. No.: US 2004/0102199 A1
(43) Pub. Date: May 27, 2004

(54) Paging area having multiple radio technologies

(76) Inventor: Serge Haumont, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/301,861

(22) Filed: Nov. 22, 2002

(51) Int. Cl. H04Q 7/20

(52) U.S. Cl. 455/458; 455/403

(57) ABSTRACT

There is disclosed a method of paging a user equipment in a paging area served by first and second serving nodes respectively associated with first and second radio technologies, comprising receiving a paging request at one of said serving nodes, and selectively paging the user equipment from at least one of said serving nodes.

### FIELD OF THE INVENTION

The present invention relates to paging areas in a network environment where multiple radio technologies are used with typically one radio technology overlaying another. The invention is particularly but not exclusively concerned with paging areas in a GSM/UMTS system where 2G and 3G cells are provided in tandem.

### BACKGROUND OF THE INVENTION

UMTS (Universal mobile telecommunications system) systems, or so-called 3G (3^{rd} Generation) mobile telecommunication systems, are likely to be introduced alongside existing GSM, or so-called 2G (2^{nd} Generation) mobile telecommunication systems. As such, 3G cells or radio coverage areas will overlay 2G cells.

However, such 2G and 3G cells are unlikely to be identically co-incident. Particularly, it is likely that there will be areas where there is both 2G and 3G coverage, and areas where there is only 2G coverage—3G coverage not being as extensive as 2G coverage. As such user equipment (UE) having both 2G and 3G capability may move through areas where the type of radio access available varies between only 2G and 2G with 3G. When the UE is located in an area covered by both 2G and 3G technology, the UE selects (based on radio signal quality, parameters set by operator, etc.) a 2G cell or a 3G cell to camp-on. When the UE is moving, as radio signal quality changes, it may select a different cell, possibly using a different radio technology, to camp-on.

The 3GPP standards allow two options: a separate serving GPRS support node (SGSN) for each type of radio technology (i.e. 2G or 3G); or a combined SGSN (i.e. a single SGSN having 2G and 3G functionality). The drawbacks associated with each of these options are discussed hereinbelow. When separate serving GPRS support nodes (SGSNs) are used to support packet services in the 2G and 3G radio networks, the 2G network has a given routing area supported by a 2G SGSN, and the 3G network has another given routing area supported by a 3G SGSN. As such, every time a UE moves between 2G and 3G cells, the routing area changes and so a routing area update is required. Thus an inter-SGSN, inter-system routing area update must take place when a UE changes radio technology. The movement between 2G and 3G cells may be due to the poor quality of the 3G coverage, or due to service based cell reselection. In an area with poor 3G coverage, there will be a significant amount of signaling throughout the network. Such signaling is disadvantageous, and uses up valuable network resources.

When a combined serving GPRS support node (2G+3G-SGSN) is used to support packet services in 2G and 3G radio networks, the combined 2G and 3G SGSN can be connected to a single routing area containing both 2G and 3G cells. As such, a routing area update is not required every time a UE moves between 2G and 3G cells. The routing area updates follow the normal selective RA update procedures.

A selective RA update procedure in accordance with known standard techniques for a combined SGSN (2G+3G-SGSN) is described hereinafter. In up-link signalling or for data transmission, in standby mode or idle state the UE does not perform an RA update procedure until uplink data or signalling information is to be sent from the UE. If the UE is in the same access network as when it last sent data or signalling information, the update procedures defined for that access system are followed. If the UE is in a different access network compared to when it last sent data or signalling information, an RA update procedure is performed before the sending of data or signalling. The RA update procedure need not be performed if the signalling information message is a power-off detach.

In downlink signalling or for data transmission if the combined SGSN (2G+3G-SGSN) receives data destined for a UE which is in standby (2G) or PMM (packet mobility management)-idle (3G) state, the SGSN pages the UE in the RA where the UE is located. This may include both 2G and 3G cells. If the UE receives this page in the same access network in which it last sent data or signalling information, the update procedures defined for that access system are followed.

If however the UE receives the page in a different access network than that in which it last sent data or signalling information, an RA update procedure is performed. The combined SGSN (2G+3G-SGSN) accepts the routing area update (RAU) as a valid response.

It is an object of the present invention to provide an improved technique, which addresses one or all of the above-stated problems.

### SUMMARY OF THE INVENTION

In view of the problems associated with the combined SGSN (2G+3G-SGSN), the present invention particularly provides a solution to the problem of using separate 2G and 3G SGSNs, but without a significant amount of RA updates.

The invention proposes such a technical solution allowing to use separate 2G and 3G SGSNs, and where the UE performs RA updates based on selective RA update procedures.

In accordance with one aspect, the invention thus provides a method of paging a user equipment in a paging area served by first and second serving nodes respectively associated with first and second radio technologies, comprising receiving a paging request at one of said serving nodes, and selectively paging the user equipment from at least one of said serving nodes.

The method may further comprise the step of determining the serving node with which the user equipment is associated, and selecting such serving node for paging the user equipment.

The step of determining may be based on the probability of the user equipment being associated with a serving node. The determining step may determine that the user equipment is associated with the serving node receiving the paging request, wherein the serving node receiving the request is selected to page the user equipment. The determining step may determine that the user equipment is not associated with the serving node receiving the paging request, the method further comprising the step of forwarding the paging request to the other serving node, wherein the other serving node is selected to page the user equipment.

The method may comprise selectively paging the user equipment from one of said serving nodes. The method may comprise selectively paging the user equipment from both of said serving nodes.

The method may further comprise the step of forwarding the paging request from the one of said serving nodes to the other of said serving nodes.

Responsive to receipt of a paging request originating from a serving node with which the user equipment is associated, the user equipment may respond to said serving node.

Responsive to receipt of a paging request originating from a serving node with which the user equipment is not associated, the user equipment initiates a routing area update with the serving node with which it is associated. Responsive to said routing area update the user equipment may be associated to the serving node from which the paging request originated.

The first and second radio technologies may be second and third generation mobile communication technologies. The second generation mobile communication technology may be GSM. The third generation mobile communication technology may be UMTS. The serving nodes may be serving GPRS support nodes. The paging request may be responsive to a paging trigger comprising any one of: a data message; a signaling message; a short messaging service message; or a circuit switched paging message.

The invention further provides a serving node associated with a radio technology for serving a paging area, the paging area further being associated with a further serving node associated with a further radio technology, the serving node being adapted to receive a paging request, and selectively transmit such paging request to the further serving node.

The serving node may be adapted to determine a radio technology associated with a user equipment associate with the paging request.

The paging request may not transmitted to the further serving node responsive to the radio technology associated with the user equipment being said radio technology. The paging request may be transmitted to the further serving node responsive to the radio technology associated with the user equipment being the further radio technology.

The serving node may include an output means for selectively transmitting said paging request. The serving node may include a control means for selectively controlling the output means.

The serving node may further include an output means for selectively transmitting said paging request in a radio network associated with said radio technology.

The invention further provides a serving node associated with a radio technology for serving a paging area, the paging area further being associated with a further serving node associated with a further radio technology, said routing node being adapted to receive a paging request from the further serving node.

The serving node may include input means for receiving said paging request. The serving node may be further adapted to transmit said paging request in a radio access network associated with the serving node. The serving node may include an output means for transmitting the paging request. The serving node may further be adapted to receive a paging request from a core network associate with said serving node. The serving node may further include an input means for receiving the paging request. The serving node may further be adapted to transmit the paging request through a radio access network associated with the first radio access technology.

The invention may still further provide a communication system comprising a first serving node for a paging area and a second serving node for the paging area, the first and second serving nodes being associated with first and second different radio technologies, the system further comprising an interconnection between the first and second serving nodes for forwarding a paging request received at one serving node to the other serving node.

The invention thus provides a new interface between a 2G SGSN and a 3G SGSN for use in forwarding paging. This advantageously allows a 2G SGSN to page in 3G cells by sending the paging message to the 3G SGSN, and having the 3G SGSN forward the paging in all 3G cells of the routing area. The converse applies from a 3G SGSN perspective.

As such, from the point of view of the user equipment it appears that the area is served by a combined SGSN (2G+3G-SGSN), and so selective RA update procedures can be used.

### BRIEF DESCRIPTION OF THE DRAWINGS

For a better understanding of the present invention and as to how the same can be carried into effect, reference will now be made by way of example to the accompanying drawings in which:

FIG. 1 illustrates an example of a 2G network and an over-layered 3G network, within which context an embodiment of the present invention is described;

FIG. 2 illustrates a signaling flow between network elements in accordance with an embodiment of the present invention;

FIG. 3 illustrates method steps in accordance with the embodiment of FIG. 2; and

FIG. 4 illustrates an exemplary implementation of the serving nodes of FIG. 1 in accordance with the present invention.

### DESCRIPTION OF THE PREFERRED EMBODIMENTS

The present invention is described herein with reference to a particular illustrative embodiment. However, such embodiment is presented for the purposes of illustrating the present invention, and does not limit the scope thereof.

The present invention particularly relates to a paging area served by first and second serving nodes associated with respective first and second radio technologies. As such, each of the first and second serving nodes may be considered to be associated with a respective first and second radio access networks, having first and second radio coverage areas.

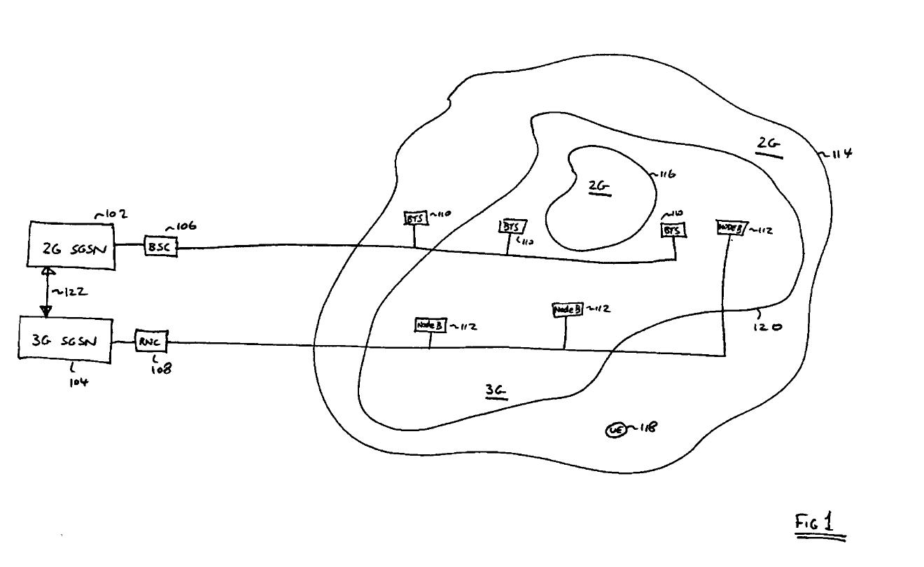

Referring to FIG. 1, there is illustrated a network scenario where a cell area provides both 2G and 3G radio coverage. In FIG. 1, a 2G SGSN (serving GPRS support node) 102 is connected to a BSC (base station controller) 106, which in turn supports a plurality of BTSs (base transceiver stations) 110. The plurality of BTSs 110 provide radio coverage for a 2G mobile communications network in a physical area generally designated by the reference numeral 114 in FIG. 1.

Further in FIG. 1, a 3G SGSN 104 is connected to a RNC (radio network controller) 108, which in turn supports a plurality of node Bs 112. The plurality of node Bs 112 provide radio coverage for a 3G mobile communications network within the physical area 114 in FIG. 1. The area of 3G radio coverage is generally designated by the reference numeral 120 in FIG. 1. The areas designated by reference numeral 114 and 120 define a single routing area, RA1, for the mobile communication system. In some situations, the area of 3G radio coverage will generally be smaller than that of 2G radio coverage, and this is illustrated in FIG. 1.

As such, the areas designated by reference numerals 114 and 120 are intended to provide radio coverage for 2G and 3G services respectively. In the example shown in FIG. 1, 3G radio coverage is not as extensive as 2G radio coverage, and further there are pockets within the area 120 within which only 2G coverage is provided. An example of such an area is illustrated in FIG. 1 by the area 116.

As such, a user of user equipment, such as user equipment 118, roaming in the area 114, will pass through areas where 2G and 3G radio coverage is provided, and areas where only 2G radio coverage is provided. The UE may therefore be camping on a 2G cell or on a 3G cell. However, the UE is registered in the last SGSN where it performed a RA update, or where it attached to if no RA updates have been performed. As the UE preferably uses selective RA update procedures, the SGSN where the UE is registered may not support the radio network where the UE is currently camping. As the SGSN must be capable of reaching the UE in the case of an incoming message (e.g. a PDU (Packet Data Unit); an SMS; or a signaling message), there is in accordance with the present invention provided a means to page the UE through another SGSN which does support the radio network in which the UE is currently camping, as described in further detail hereinbelow.

In accordance with the present invention, there is provided an interface between the 2G SGSN 102 and the 3G SGSN 104, identified in FIG. 1 by reference numeral 122. As will be discussed in further detail hereinbelow, the provision of the interface 122 allows for any routing area updates between the 2G and 3G areas to be minimized. The invention is now further illustrated by way of reference to particular examples.

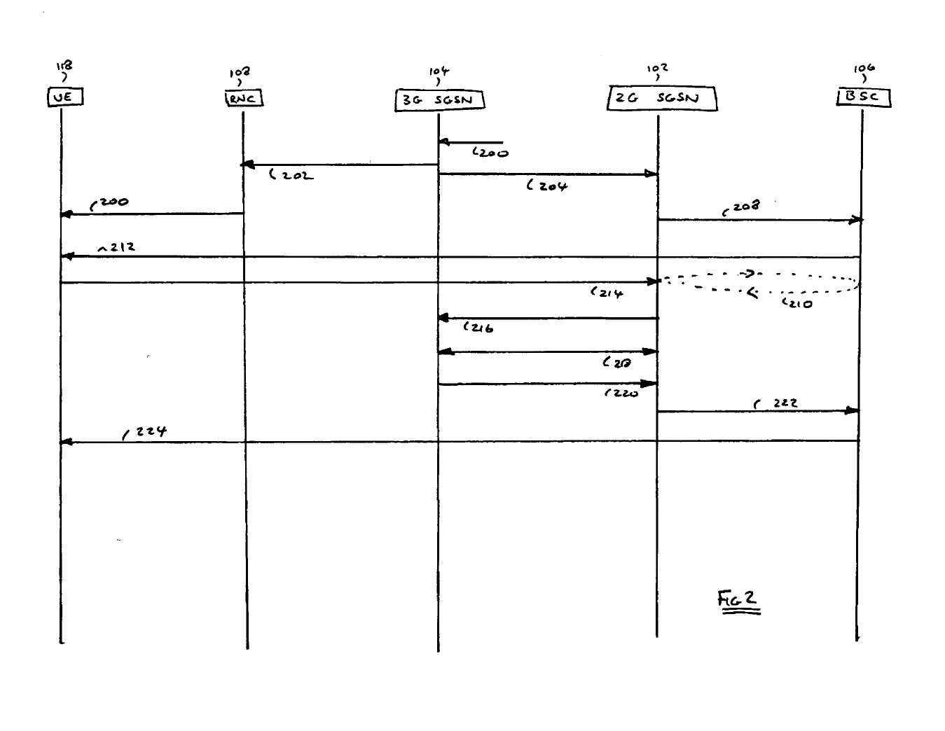

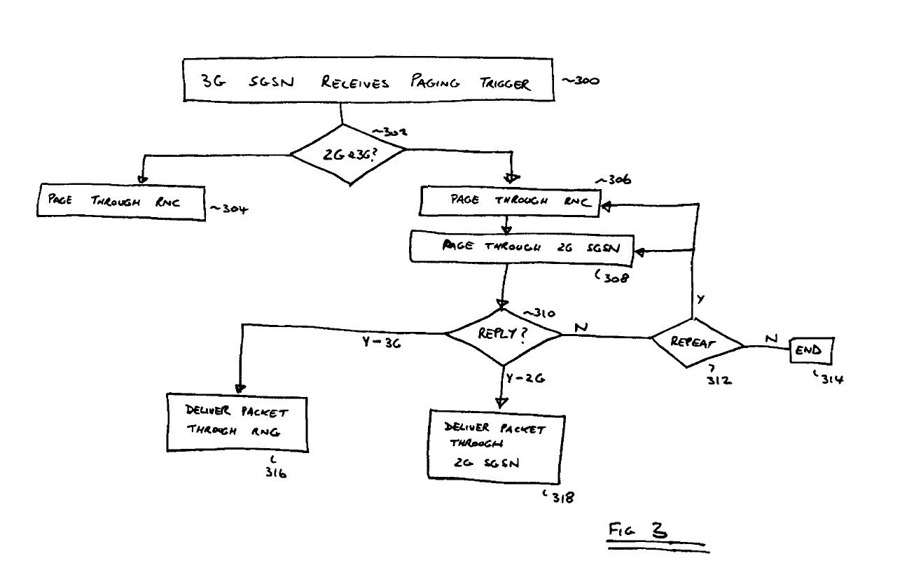

A first example is described with reference to FIGS. 2 and 3, in which a paging is initiated by the 3G SGSN 104.

In a step 300, the 3G SGSN 104 receives a paging trigger 200 (e.g. an incoming message) from the mobile communications network. For the purposes of this example, the paging trigger is a downlink PDU (protocol data unit). In a step 302, the 3G SGSN determines the radio access capabilities of the UE 118. If the UE only supports 3G services, then the paging of the UE proceeds in accordance with conventional techniques, as represented by step 304.

However, if the UE supports both 2G and 3G services, then in the embodiment of FIGS. 2 and 3, the 3G SGSN initiates two pagings in parallel:

1. In a first step 306 the 3G SGSN 104 initiates a page 202 through the RNC 108, in accordance with techniques known in the art.

2. In a second step 308, in accordance with the present invention, the 3G SGSN 104 initiates a page through the 2G SGSN 102, by sending a page command 204 to the 2G SGSN on the interface 122.

As such, each SGSN is preferably adapted to be provided with a list of routing areas or location areas for which paging should be made through another SGSN, and the address of any such other SGSN.

In a further, preferred embodiment, designed to save paging capacity, the paging is not made in parallel if it is determined that the UE has a high probability to be camping on a cell in a particular radio network, e.g. a 3G cell. Such probability is preferably determined by the fact that the UE had a connection with a 3G cell (e.g. RA Update) within a certain time period, e.g. less than 15 second ago. Alternatively, the probability may be determined based on the fact that the 3G coverage of the area is known to be excellent.

The quality of 3G coverage in an area can be determined based on, for example, configuration parameters, or it can be detected by the 3G SGSN measuring the success rate of paging in the 3G cells of the RA. However, if no answer is received by transmitting through a single radio technology based on probability, the paging is preferably repeated in both 2G and 3G cells.

The paging request 204 on the communication interface 122 requires a new message carrying the relevant information for paging. This new message may be sent using s GTP protocol

In a preferred embodiment, the new message has the following structure:

GTP header
IMSI
Temporary UE
Identity
Paging Area ID
Paging Cause
DRX Cycle Length
Coefficient
QoS

The GTP header indicates a new message type, namely “paging”, as well as the normal GTP header information (e.g. length). IMSI is the subscriber identity of the UE being paged. The Temporary UE Identity IE (TMSI for paging originated by the MSC; P-TMSI for paging originated by the SGSN) is the temporary identity of the user which can be used in a radio interface paging message. The Paging Area IE identifies the area (e.g. RA or Location area) in which the radio interface paging message is broadcast. The Paging Cause IE indicates to the 3G SGSN the reason for sending the PAGING message. The DRX Cycle Length Coefficient IE may be included in the PAGING message, and if present, forwarded to the UTRAN that uses it for calculating the paging occasions for the UE. The Quality of Service indicates to the 2G SGSN the QoS profile associated with the PAGING message.

The 3G SGSN is preferably adapted to have a configuration giving the 2G SGSN IP address for each routing area (or in alternative implementations, location area). This allows the paging request to be addressed appropriately. The 2G SGSN is adapted to receive the paging request 204 and use the information contained therein to send a paging request 208 to the BSC. Such an adaptation of the 2G and 3G SGSN will be well within the scope of one skilled in the art.

Referring again to the embodiment shown in FIGS. 2 and 3, in a step 310, the 3G SGSN 104 determines whether a paging response has been received. If no response is received, then in a step 312 the 3G SGSN 104 determines whether the paging should be repeated.

In a first alternative, there is provided a single repetition timer, i.e. a delay before re-transmission, and a single number of attempts for both radio technologies, based on the expected response time of the slower radio technology. In a second alternative the repetition timer and the number of attempts may be different for the RNC 108 and the 2G SGSN 102. This is because the time expected to receive a paging response may be different, and so a different timer will increase the chance to have a quick response time (at the expense of possible extra paging load). Thus from step 312 steps 306 and 308 may be activated together or independently.

It should be also noted that although steps 306 and 308 are shown as being performed in sequence, they may be initiated in parallel or in an inverse sequence.

If no reply, i.e. neither a service request nor a “SGSN context request” message (see below), is received to the paging request, and the repeat steps determines that the paging should time-out, in a step 314 the paging is terminated. Thus if the 3G SGSN 104 does not receive a paging reply then the paging request will time out due to the non-availability of the UE.

If the UE receives a paging request while camping on a 3G cell, a paging reply (using a service request message) is sent directly to the 3G SGSN 104. In such a case, where a reply is received through the 3G radio network, then in a step 316 the PDU (stored in the 3G SGSN during the paging procedure) is forwarded to the UE via the RNC 108.

If the UE receives the paging request while camping on a 2G cell, the UE replies with a routing area update request to the 2G SGSN 102 as defined by the known selective RA update procedure. The 2G SGSN follows the standard inter-SGSN RA update procedure and sends a “SGSN context request” message to the 3G SGSN. The 3G SGSN stops the paging procedure, and proceeds with a normal inter-SGSN RA update procedure which includes forwarding the PDU to the 2G SGSN. Thus, as represented by step 318 in FIG. 3, responsive to a reply received in the 2G radio network, the packet is delivered to the 2G SGSN as part of the inter-SGSN RAU, and further forwarded to the UE by the BSC 106.

In the example of FIG. 2, the 2G SGSN sends a paging request 208 to the BSC 106. In a similar manner each of the BSC 106 and the RNC send paging signals to the UE 118. The BSC 106 sends a paging signal 212, and the RNC sends a paging signal 206. In the example of FIG. 2, the UE 118 receives the paging signal via the BSC 106, i.e. via the 2G SGSN 102. This indicates that the UE is no longer in the 3G coverage area, as the 3G paging request was not received. As such, the UE 118 initiates a routing area update with a message 214 to the 2G SGSN 102. This message is transmitted to the 2G SGSN via the BSC 106, which normally simply forwards such message, as represented by dashed loop 210. In a step 216 the 2G SGSN sends a “SGSN context request” message to the 3G SGSN 104

As represented by bi-directional signal 218 in FIG. 2, an inter-SGSN RAU takes place between the 2G SGSN 102 and the 3G SGSN 104. This includes, as represented by signal 220, the forwarding of the PDU packet to the 2G SGSN. Thereafter, the PDU packet is forwarded to the BSC with a signal 222, and to the UE with a signal 224. The routing area update initiated by the UE 118 is in accordance with 3GPP standard procedures, and are not described in detail herein. After the routing area update, as described the packet associated with the initial paging request 200 is delivered to the UE.

The invention preferably applies, in the context of the described 2G and 3G environment, to UEs which are not 3G connected or 2G ready. As such the described embodiment of the invention is relevant for UEs which are 3G idle or 2G stand-by. In general, however, it should be noted that the invention is applicable to any environment having more than one radio technology, and is not limited to 2G or 3G radio technologies specifically. The usefulness of the invention may apply in different scenarios in different radio technologies,

The above example described with reference to FIGS. 2 and 3 illustrates an example where the paging is initiated through a 3G SGSN. The same mechanism may be implemented for the case where the paging is initiated through a 2G SGSN. In such a case, the 2G SGSN sends a paging message to the UE both directly (through the BSC) and indirectly (through the 3G SGSN) using a message similar to the message 204. One skilled in the art will appreciate how the above description may be simply applied to such a case.

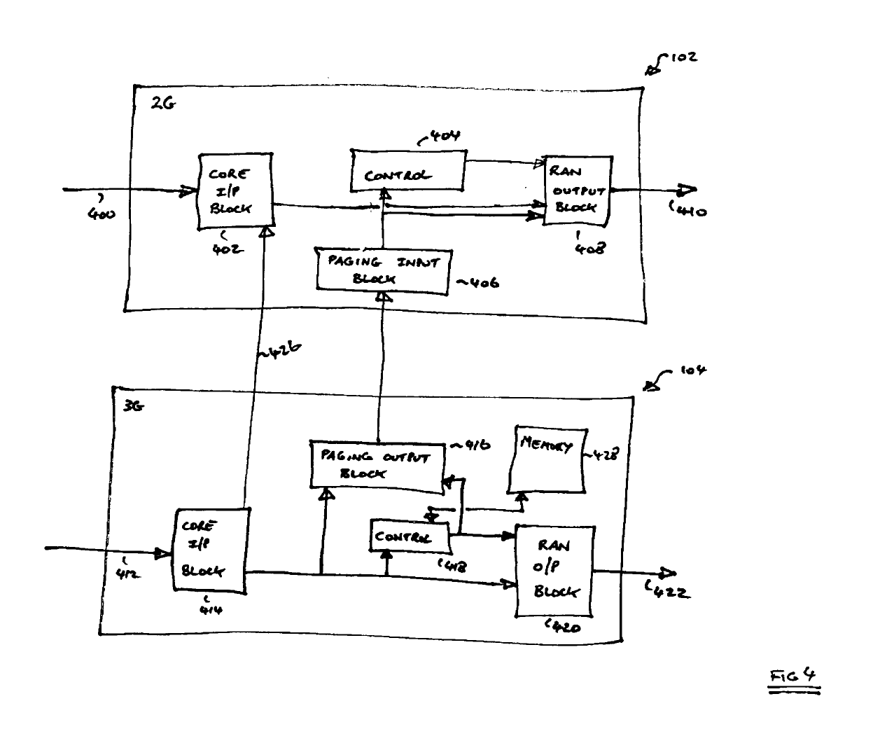

Referring to FIG. 4, there is illustrated, schematically, an implementation of the serving nodes 102 and 104 of FIG. 1 for a particular embodiment of the invention. Only those parts of the serving nodes necessary for an understanding of an implementation of the embodiment are shown. The other parts necessary to implement the functionality of the serving node will be familiar to one skilled in the art. Further the specific implementation of the adaptations necessary for performing embodiments of the present invention will be within the scope of one skilled in the art.

FIG. 4 illustrates an embodiment in which the 3G serving node 104 is adapted to forward paging requests to the 2G serving node 102, but not adapted to receive paging requests from the 2G SGSN 102. Correspondingly, the 2G serving node 102 is adapted to receive paging requests from the 3G serving node 104, but is not adapted to send paging requests to the 3G serving node 104. Such an implementation may be advantageous where it is assumed that user equipment always has 2G coverage, but only limited 3G coverage.

Referring to FIG. 4, the serving node 104 receives a paging request on an input line 412 from the core network, at a core input block 414. The received paging request is then forwarded to each of a paging output block 416, a control block 418, and a RAN (radio access network) output block 420. The control block 418 controls the operation of the serving node 104 for the purpose of performing paging to the UE, and provides control inputs to the paging output block 416 and the RAN output block 420.

The control block 418 controls the operation of the serving node 104 in accordance with embodiments of the present invention as described hereinabove. In one embodiment, as described above, the control block 418 determines the radio access capabilities of the UE. This may be done by retrieving the identity of the UE from the paging request, and retrieving from a memory 428 connected to the control block information associated with that UE. In dependence on the capabilities of the UE, the control block then selectively activates the RAN output block 420 to page the UE, and the paging output block 416 to forward the paging request to the serving node 102.

As discussed hereinabove, in a different embodiment the memory may include a list of routing areas (or location areas) for which paging should be done through a different serving node. Such list may be accessed by the control block 418 based on an identity of the routing area for the UE.

In a still further embodiment discussed hereinabove, the memory 428 may store information for each UE identifying the probability of the UE being accessible in a particular radio technology. Such information stored in the memory may be dynamically updated. In dependence on the information stored in the memory, the control block may selectively control the output blocks 416 and 420 to transmit a paging request.

Thus, in accordance with the different embodiments, the control block may control the output blocks 416 and 420 such that only the output block 420 forwards the paging request, or only the output block 416 forwards the paging request, or both the output blocks 416 and 420 forward the paging request.

When selected, the paging output block 416 outputs a paging request toward the serving node 102. When selected, the RAN output block 420 outputs a paging request on line 422 directly toward the UE.

At the serving node 102, a paging input block 406 receives any paging request from the paging output block 416. The received paging request is forwarded to a control block 404 and a RAN output block 408. The RAN output block further receives a control signal from the control block 404, and forwards the paging request on an output 410 under the control of the control signal.

The serving node 102 also includes a core input block for receiving signals from the associated core network on an input line 400. Such signals are forwarded to the RAN output block 408 for transmission on the output line 410.

FIG. 4 also shows a connection from the core input block 414 of the serving node 104 to the core input block 402 of the serving node 102. This represents the transfer of, for a example, a PDU associated with the paging request from the serving node 104 to the serving node 102, following a routing area update. The transfer of such packet may alternatively be from the output block 416 to the output block 406.

Although in FIG. 4 only one serving node has the capability to forward paging requests, and only one serving node has the capability to receive paging requests, in other embodiments both serving nodes may have the capability to forward paging requests and receive forwarded paging requests. Therefore serving nodes may include the functionality of both the serving nodes 102 and 104.

FIG. 4 shows a possible implementation of serving nodes adapted in accordance with embodiments of the present invention. Various other implementations are possible, and will be apparent to one skilled in the art.

The description of an exemplary embodiment hereinabove is related to the delivery of a PDU to the UE. The invention is not limited to such a paging trigger. Other possible paging triggers are discussed below.

The paging may be caused by a signaling message to be delivered to the UE. An SGSN may need to reach the UE in order to signal a PDP context modification or deactivation which may come from the GGSN (gateway GPRS support node) or a HLR (home location register). If the UE camps on a cell from a different radio technology than the SGSN, the UE performs a RA update procedure which cancels the modification/deactivation procedure. The old SGSN sends to the new SGSN the SGSN context without taking into account the modification/deactivation procedure. The new SGSN detects that the PDP context is to be modified/deactivated when:

1. Comparing the active PDP context parameters to the subscribed PDP context parameters (received from the HLR) in order to check that the active PDP contexts are consistent with the subscriber data. This covers the case where modification/deactivation is triggered from the HLR.

2. The GGSN sends an update PDP context response containing the new parameters (in the case of modification), or the GGSN rejects the update (for the deleted PDP context).

In a preferred embodiment, deactivated PDP context(s) are not sent in the SGSN context response. The SGSN will detect the need to perform the PDP context deactivation from the PDP context status information sent in the RA Update request message by the UE.

The paging may also be caused by a CS (circuit switched) paging received by the SGSN from the Gs interface. The SGSN forwards the CS paging to its own radio network (using standard procedures) and through the other SGSN using the message 204. The message 204 contains the relevant information for CS paging, such as message type. Such a paging message will be answered directly toward a mobile switching center (MSC) of the circuit switched network, and any possible retransmission of the paging is handled by the MSC and not by the SGSN. Therefore the SGSN role is limited to forwarding the paging message.

If the paging (initiated either through the 2G or the 3G network) is triggered by an SMS (short messaging service), the SMS cannot, in current system implementations, be forwarded from one SGSN to the other. Thus were the result of the paging indicates that the SGSN should be changed, it is not possible in current systems to forward the SMS from the old SGSN to the new SGSN. In current systems, in accordance with GSM 23.040, the old SGSN should reject the SMS, the cause code being “MS (mobile station) busy for MT (mobile terminal) SMS”. Following such rejection, and issuance of the cause code, the SMS-GMSC (gateway mobile switching center) is triggered to retry sending the SMS through the MSC/VLR (visiting location register), or the SMS-SC (service center) retries delivering the SMS later.

This is disadvantageous, as after the paging request which was triggered to send the SMS message, the SMS message cannot be sent immediately.

Therefore, in accordance with a preferred embodiment of the present invention, the interface 122 provided between the 2G SGSN 102 and the 3G SGSN 104 is further adapted to allow the SMS to be transmitted there between. This could be achieved by encapsulating the SMS information contained in a MAP message into a GTP message for example. That is, the information sent in the MAP message is preferably taken and copied to a GTP message when transferring an SMS message.

An additional point to note is that when a UE moves to a new SGSN, this new SGSN needs to resolve the address of the old SGSN based on the RAI (routing area information). This problem also arises in current systems in the Iu flex (officially called in 3GPP Intra-domain Connection of Radio Access Network (RAN) Nodes to Multiple Core Network (CN) Nodes), and those known solutions may also be applied to the present invention. It should be noted that a 2G and 3G SGSN sharing the same routing area should preferably have different NRI (network routing information).

In accordance with the present invention, a single routing area (RA) which has both 2G and 3G cells is connected to separate 2G and 3G SGSNs.

The invention thus advantageously reduces the number of inter-system inter-SGSN routing area updates compared to when separate 2G and 3G SGSNs are used in a network. The UE does not always make a routing area update when changing RAT (radio access technology). It only performs routing area update if it is in ‘ready’ mode or in ‘MM’ connected mode when changing RAT (radio access technology). The radio load is equivalent to a combined SGSN.

The present invention is described herein with reference to examples of preferred embodiments for the purpose of illustration, and is not limited to any such embodiments. In particular, the invention may apply to other updating procedures such as location update. The invention may also apply to any other types of radio technology operating together. The invention is thus not limited to the use of SGSNs. The invention may be applied to any network element supporting a radio technology interface. Such a network element may be generally referred to as a serving node.

The invention has been described herein by way of reference to different radio technologies operating in a single routing area. The invention is not limited to routing areas, and as discussed hereinabove is equally applicable to location areas.

In general, the term paging area may be used to refer to the area where the user equipment or mobile station is paged. The paging area is a routing area in a GPRS system (2G and 3G SGSN tracks user equipment in the routing area), and a location area in a circuit switched system (2G and 3G MSC/VLR tracks a mobile station in the location area). In other applications/architectures the term paging area may generally describe the are within which a user os user equipment is paged.

Modifications and alterations to the described embodiments will be apparent to one skilled in the art. The scope of the present invention is defined by the appended claims.

1. A method of paging a user equipment in a paging area served by first and second serving nodes respectively associated with first and second radio technologies, comprising receiving a paging request at one of said serving nodes, and selectively paging the user equipment from at least one of said serving nodes.

2. A method according to claim 1 further comprising the step of determining the serving node with which the user equipment is associated, and selecting such serving node for paging the user equipment.

3. A method according to claim 2 wherein the step of determining is based on the probability of the user equipment being associated with a serving node.

4. A method according to claim 2 or claim 3 wherein the determining step determines that the user equipment is associated with the serving node receiving the paging request, wherein the serving node receiving the request is selected to page the user equipment.

5. A method according to claim 2 or claim 3 wherein the determining step determines that the user equipment is not associated with the serving node receiving the paging request, the method further comprising the step of forwarding the paging request to the other serving node, wherein the other serving node is selected to page the user equipment.

6. A method according to any one of claims 1 to 5, comprising selectively paging the user equipment from one of said serving nodes.

7. A method according to any one of claims 1 to 5, comprising selectively paging the user equipment from both of said serving nodes.

8. A method according to any one of claims 1 6, or 7 further comprising the step of forwarding the paging request from the one of said serving nodes to the other of said serving nodes.

9. A method according to any preceding claim wherein responsive to receipt of a paging request originating from a serving node with which the user equipment is associated, the user equipment responds to said serving node.

10. A method according to any preceding claim wherein responsive to receipt of a paging request originating from a serving node with which the user equipment is not associated, the user equipment initiates a routing area update with the serving node with which it is associated.

11. A method according to claim 10, wherein responsive to said routing area update the user equipment is associated to the serving node from which the paging request originated.

12. A method according to any preceding claim wherein the first and second radio technologies are second and third generation mobile communication technologies.

13. A method according to claim 12 wherein the second generation mobile communication technology is GSM.

14. A method according to claim 12 or claim 13 wherein the third generation mobile communication technology is UMTS.

15. A method according to any preceding claim wherein the serving nodes are serving GPRS support nodes.

16. A method according to any preceding claim, wherein the paging request is responsive to a paging trigger comprising any one of: a data message; a signaling message; a short messaging service message; or a circuit switched paging message.

17. A serving node associated with a radio technology for serving a paging area, the paging area further being associated with a further serving node associated with a further radio technology, the serving node being adapted to receive a paging request, and selectively transmit such paging request to the further serving node.

18. A serving node according to claim 17 adapted to determine a radio technology associated with a user equipment associate with the paging request.

19. A serving node according to claim 18 wherein the paging request is not transmitted to the further serving node responsive to the radio technology associated with the user equipment being said radio technology.

20. A serving node according to claim 18 wherein the paging request is transmitted to the further serving node responsive to the radio technology associated with the user equipment being the further radio technology.

21. A serving node according to any one of claims 17 to 20 including an output means for selectively transmitting said paging request.

22. A serving node according to claim 21 including a control means for selectively controlling the output means.

23. A serving node according to any one of claims 17 to 22 further including an output means for selectively transmitting said paging request in a radio network associated with said radio technology.

24. A serving node associated with a radio technology for serving a paging area, the paging area further being associated with a further serving node associated with a further radio technology, said routing node being adapted to receive a paging request from the further serving node.

25. A serving node according to claim 24 including input means for receiving said paging request.

26. A serving node according to claim 24 or claim 25 further adapted to transmit said paging request in a radio access network associated with the serving node.

27. A serving node according to claim 26 including an output means for transmitting the paging request.

28. A serving node according to any one of claims 24 to 27 further being adapted to receive a paging request from a core network associate with said serving node.

29. A serving node according to claim 28 further including an input means for receiving the paging request.

30. A serving node according to claim 28 or claim 29 further adapted to transmit the paging request through a radio access network associated with the first radio access technology.

31. A communication system comprising a first serving node for a paging area and a second serving node for the paging area, the first and second serving nodes being associated with first and second different radio technologies, the system further comprising an interconnection between the first and second serving nodes for forwarding a paging request received at one serving node to the other serving node.
